(19) United States
(12) Patent Application Publication
(10) Pub. No.: US 2026/0059613 A1
(43) Pub. Date: Feb. 26, 2026

(54) IMPACT RESISTANT LEADS FOR ELECTRICAL RESISTANCE HEATING

(71) Applicant: JERRY P BUNCH, JR., FORT MYERS, FL (US)

(72) Inventor: JERRY P BUNCH, JR., FORT MYERS, FL (US)

(21) Appl. No.: 19/309,161

(22) Filed: Aug. 25, 2025

Related U.S. Application Data
(60) Provisional application No. 63/687,063, filed on Aug. 26, 2024.

(51) Int. Cl. H05B 3/02

(52) U.S. Cl. CPC H05B 3/02

(57) ABSTRACT

An electrically resistive heating apparatus includes a conductor having a selected resistance to generate a selected quantity of heat when energized in order to provide electrical resistive heating. An insulation layer encloses the conductor in biased engagement with the conductor. The insulation layer comprises a material selected from a group consisting of polyetherimide (PEI) and polyether ether ketone (PEEK).

### CROSS-REFERENCE TO RELATED APPLICATIONS

This application claims priority and benefit of U.S. Provisional Patent Application No. 63/687,063 filed 26 Aug. 2024, which is hereby incorporated by reference in its entirety herein.

### BACKGROUND OF THE INVENTION

Radiant heating systems are a convenient and effective method of providing comfort heat to rooms or spaces. These electric radiant heating systems provide an electrically resistive heat source within or below a floor or within or above a ceiling that, in turn, provides heat to the surrounding environment via conduction, convection and/or radiant heat transfer. As further examples, electric radiant heating systems may be used in snow melt applications, for pipe freeze protection, and in automotive applications such as heated car seats and heated steering wheels.

Both UL (Underwriters Laboratory) and CSA (Canadian Standards Association) testing agencies have issued new more stringent testing standards for leads including cables, wires, panels, mats, and sheets used, for example, as electrically resistive heat sources in electric radiant heating systems. These new testing requirement standards for leads used in such electrically resistive heating applications are stated in UL 2683 Standard for Electric Heating Systems for Floor and Ceiling Installation, 25 Feb. 2020 (hereinafter UL2683) and CSA 22.2.130 Requirements for electrical resistance trace heating and heating device sets and CSA 22.2 No. 210 2015 reaffirmed in 2020 Appliance wiring material products, (hereinafter referred to collectively as CSA 22.2). These standards measure the resistance of the lead to abrasion and cutting with a goal of increasing the lead's resistance to abrasion and cutting beyond prior standards.

For example, the Cutting Test per section 38 of the UL 2683 standard requires:
All assembled heating system parts including non-heating leads, heating elements, and integral components shall be subjected to this test. The sample is not energized during this test. A sample size representing a completed system shall be used. The sample under test shall be place on a flat steel surface and a steel cutting jig with a 0.25±0.01 mm (0.01±0.0004 in) radius edge is to be applied for one minute at a right angle to the sample with a force of 445 N (100 lbf). One cut is done on each applicable part. Electrical continuity is to be continuously monitored between live parts and the metal cutting jig. There shall not be any continuity throughout the test.

Currently, insulating materials for leads used in electric radiant heating systems may include, for example, ethylene tetrafluoroethylene (ETFE), perfluoroalkoxy (PFA), cross-linked polyethylene (XLPE) including peroxide cure, radiation cure and moisture cure, fluorinated ethylene propylene (FEP) and polyvinylchloride (PVC). Because of the use of such insulation materials, currently available leads used for resistive heating in electric radiant heating systems may not meet the new more stringent requirements of UL 2683 and CSA 22.2.

As used herein, electrical wire is comprised of an electrical conductor (e.g., a wire). The conductor may be bare (e.g., without enclosing insulation) or insulated by being enclosed by an insulation material or layers of insulation materials having a sufficient dielectric strength to contain the electrical current supplied to the energized conductor. As used herein, electrical cable includes two or more electrical wires with a protective covering (sheath or jacket) disposed around the two or more electrical wires. Leads, as used herein, includes cables, wires, panels, mats, and sheets and so forth comprising electrically conductive material(s) as may be used, for example, for resistive heating in electric radiant heating systems.

Heated leads may include a conductor formulated to provide a selected electrical resistance to the conduction of electricity when energized. This selected electrical resistance produces a corresponding selected quantity of heat when the conductor is energized.

Non-heated leads may communicate electrical power with the heated leads, and may include a conductor having low electrical resistance that produces generally negligible heat when communicating electrical power. Non-heated leads may be specifically configured to reduce resistance to current flow. Both the heated leads and the non-heated leads are required to meet the new testing standards as stated in CSA22.2 and UL2683. Additionally, as a condition of UL2683, all heated leads and non-heated leads may be required to meet UL 758 Appliance Wiring Material, 2 May 2014 standard (hereinafter UL 758) and the testing protocols of UL 1581 Reference Standard for Electrical Wires, Cables, and Flexible Cords, 30 Jun. 2021 (hereinafter UL 1581) and UL 2556 Wire and Cable Test Methods, 30 Apr. 2021 (hereinafter UL 2556). Leads used in certain industrial applications may be required to meet Heat Trace UL515.

In general, these standards govern dielectric strength, temperature requirements, and impact abrasion resistance, which are not met by currently available heated leads and non-heated leads. UL 2683, UL 758, UL 1581, UL 2556, and CSA 22.2 are all incorporated by reference in their entireties herein. Accordingly, there is a need for heated leads and non-heated leads that meet CSA22.2, UL2683, and UL758 standards.

### BRIEF SUMMARY OF THE INVENTION

These and other needs and disadvantages may be overcome by the apparatus disclosed herein. Additional improvements and advantages may be recognized by those of ordinary skill in the art upon study of the present disclosure.

An electrically resistive heating apparatus that includes a conductor having a selected resistance to generate a selected quantity of heat when energized in order to provide resistive heating, in various aspects. An insulation layer encloses the conductor in biased engagement with the conductor, in various aspects. The insulation layer comprises a material selected from a group consisting of polyetherimide (PEI) and polyether ether ketone (PEEK), in various aspects. In various aspects, the conductor has a resistance selected to cause the conductor to operate at a selected temperature when energized. The selected temperature may be from about 170° C. to about 250° C. In such self-regulating aspects, the at least portions of the insulation layer may further include conductive particles to be semiconductive.

In various aspects, the electrically resistive heating apparatus comprises a substrate with a lead disposed within the substrate, the lead comprising a conductor having a selected resistance insulated by a material selected from a group consisting of polyetherimide (PEI) and polyether ether ketone (PEEK). A controller electrically cooperates with the lead to regulate the quantity of heat being generated or to regulate the temperature of the conductor, in certain aspects.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1 illustrates by schematic view an exemplary electrically resistive heating apparatus according to aspects of the present inventions;

FIG. 2A illustrates by cross-sectional cut-away perspective view an exemplary lead of the exemplary electrically resistive heating apparatus FIG. 1;

FIG. 2B illustrates by cross-sectional view the exemplary lead of FIG. 2A;

FIG. 3 illustrates by cross-sectional cut-away perspective view a second exemplary lead of a second exemplary electrically resistive heating apparatus according to aspects of the present inventions;

FIG. 4 illustrates by cross-sectional cut-away perspective view a third exemplary lead of a third exemplary electrically resistive heating apparatus according to aspects of the present inventions;

FIG. 5 illustrates by cross-sectional view a fourth exemplary lead of a fourth exemplary electrically resistive heating apparatus according to aspects of the present inventions;

FIG. 6 illustrates by cross-sectional view a fifth exemplary lead of a fifth exemplary electrically resistive heating apparatus according to aspects of the present inventions;

FIG. 7 illustrates by cross-sectional view a sixth exemplary lead of a sixth exemplary electrically resistive heating apparatus according to aspects of the present inventions;

FIG. 8 illustrates by cross-sectional view a seventh exemplary lead of a seventh exemplary electrically resistive heating apparatus according to aspects of the present inventions; and,

FIG. 9 illustrates by cross-sectional view an eighth exemplary lead of an eighth exemplary electrically resistive heating apparatus according to aspects of the present inventions

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

An electrically resistive heating apparatus is disclosed herein. The electrically resistive heating apparatus may be used, for example, in radiant floor heating, radiant ceiling heating, in various applications directed to thawing and/or preventing freezing, in automotive applications such as heating car seats and steering wheels, and in various aircraft applications. The electrically resistive heating apparatus meets the requirements of UL 2683, CSA 22.2, UL515 IEEE 515.1 standards, in various aspects.

In various aspects, the electrically resistive heating apparatus includes a conductor having a selected resistance to generate a selected quantity of heat when energized under a selected current. This generation of the selected quantity of heat by the electrically resistive heating apparatus is in contrast, for example, with communication leads and electrical transmission leads wherein it is desirable to minimize electrical resistance in order to reduce noise in communication leads and transmission losses in electrical transmission leads. Thus, communication leads and electrical transmission leads generate negligible heat when electrically communicating.

In various aspects, an insulation layer encloses the conductor in biased engagement with the conductor with the insulation layer being selected to resist impact and cut through per the UL 2683 and CSA 22.2 standards as well as being selected to have sufficient dielectric strength to insulate the conductor. The insulation layer is configured to withstand heat generated by resistance of the conductor as well as various external insults such as cutting and abrasion, in various aspects. In various aspects, the insulation layer comprises polyetherimide (PEI), and the insulation layer may further comprise glass fiber, carbon fiber, and/or other material(s). In various aspects, the insulation layer comprises polyether ether ketone (PEEK), and the insulation layer may further comprise glass fiber, carbon fiber, and/or other material(s). In certain aspects, the insulation layer may be semiconductive. In certain aspects, the PEEK or the PEI forming the insulation layer may further comprise certain additives that may, for example, increase flexibility of the insulation layer. In certain aspects, the insulation layer may include, for example, polyethersulfone (PES), polyphenylenesulfide (PPSU) (a very rigid material), and polysulphone unfilled (PSUL). PES, PPSU, and PSUL may be used as stand alone alternatives to PEI or PEEK during times of PEI or PEEK shortages, in various aspects.

Flexibility and/or thermal expansion of the insulation layer may be enhanced by including an additive that acts, for example, as a plasticizer to increase flexibility or thermal expansion of PEI, PEEK, PES, PPSU, and PSUL. Examples of such additives include a class of compounds know as phthalates such as dioctyl phthalate (DOP) and diisononyl phthalate (DINP). Exemplary plasticizer additives include non phthalates such as triethyl citrate (TEC) and polyethylene glycol (PEG). Exemplary plasticizer additives include adipates, phosphates, citrates, succinates, and bisphenols. Blends with other polymers modify the physical properties of PEI, PEEK, and PES to improve flexibility such as polyamides (PA) (e.g., Nylons) and compounds from the family of thermoplastic polyurethanes (TPU). The inclusion of fillers may improve flexibility.

In various aspects, the insulation layer may enclose several conductors to electrically insulate the several conductors. In various aspects, one or more additional layers may enclose the insulation layer. Each of these one or more layers may be in gapped relation or in biased engagement with the layer being enclosed thereby, and each of the one or more layers enclosing the insulation layer (e.g., external of the insulation layer) may be an electrical insulator, electrically conductive, or combinations thereof, in various aspects.

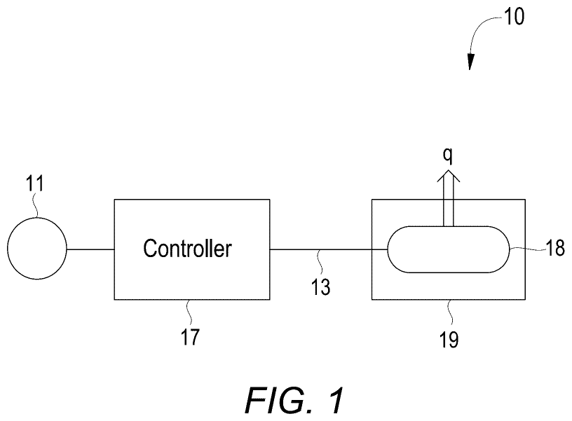

As illustrated in FIG. 1, exemplary electrically resistive heating apparatus 10 includes power source 11 in electrical communication with controller 17 by lead 13, and controller 17 is in electrical communication with substrate 19 by lead 13 to generate heat at rate q from substrate 19. Lead 13 forms loop 18 disposed about substrate 19, as illustrated. Power source 11 may be, for example, mains electric, battery, or alternator, and power source 11 may be configured as an AC source or a DC source. Substrate 19 may comprise a portion of a floor, a ceiling, a wall, or some other structure, in some implementations. In other implementations, substrate 19 may conform to the shape of a pipe or other fluid conveyance. In yet other implementations, substrate 19 may comprise a portion of a vehicle (e.g., car, truck, aircraft) such as a seat, mirror, windshield, or leading edge of an airfoil. Substrate 19 may be comprised of various materials and lead 13 may cooperate with substrate 19 in various ways, as would be readily recognized by those of ordinary skill in the art upon study of this disclosure. In this implementation, controller 17 regulates electrical communication of power source 11 with substrate 19 via lead 13 in order to control rate of heat generation q from substrate 19 or a temperature of substrate 19.

Lead 13 may be configured in various ways in electrically resistive heating apparatus 10 to form a circuit, as would be readily recognized by those of ordinary skill in the art upon study of this disclosure. Also, lead 13 may have differing configurations, for example, between power source 11 and controller 17, between controller 17 and substrate 19, and within substrate 19. Loop 18 is offered for explanatory purposes, and lead 13 may assume a variety of configurations with respect to substrate 19, as would be readily recognized by those of ordinary skill in the art upon study of this disclosure.

In floor heating applications (e.g., substrate 19 comprises at least a portion of a floor), lead 13 may have a temperature between about 25° C. (77° F.) and about 29° C. (84.2° F.). The maximum temperatures that the flooring surface should reach, which is limited by controller 17, may be between about 24° C. (75° F.) and about 36° C. (96.8° F.). In industrial pipe freeze/snow and ice melt applications, warming (viscosity reducing) applications are either self-regulating or controller 17 regulates temperature, for example, to a range between about 3° C. (37.4° F.) and about 5° C. (41° F.) with heat generation q generally in a range between about 9.84 W/m (3 W/ft) and about 65.6 W/m (20 W/ft).

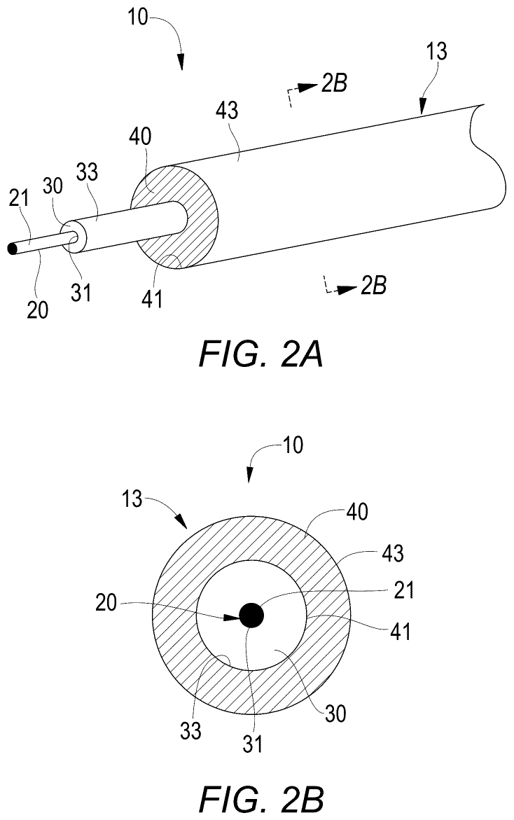

As illustrated in FIGS. 2A, 2B, lead 13 of exemplary electrically resistive heating apparatus 10 includes conductor 20, insulation layer 30, and layer 40. Conductor 20 may for example, comprise a metal and conductor 20 is configured to communicate electrical power. Although conductor 20 is illustrated as of solid configuration with a circular cross-section for explanatory purposes, it should be recognized that conductor 20 may be of various configurations such as a stranded configuration (e.g., concentrically stranded) and that conductor 20 may have various non-circular cross-sections such as rectangular or hexagonal, in other implementations.

As illustrated in FIGS. 2A, 2B, insulation layer 30 is disposed around conductor 20 to electrically insulate conductor 20 with surface 31 defined by insulation layer 30 in biased engagement with conductor surface 21 of conductor 20. Insulation layer 30 may be extruded or enameled onto conductor to enclose and bond to conductor 20 in order to insulate conductor 20. Surface 41 of layer 40 is bonded to surface 33 of insulation layer 30 to bond layer 40 to insulation layer 30, as illustrated. Surface 43 of layer 40 defines the outer surface of lead 13, in this implementation. Of course, some implementations of lead 13 may only include conductor 20 enclosed by insulation layer 30. Other implementations may have several additional layers such as layer 40 variously bonded to each other, biased with each other but not bonded, or otherwise in intimate contact with each other in succession around insulation layer 30. Certain implementations of lead 13 may include a drain or ground wire (not shown) in addition to conductor 20.

Insulation layer 30 may include PEI and insulation layer 30 may include PEEK. In various implementations, insulation layer 30 may consist of PEI or consist essentially of PEI. In various implementations, insulation layer 30 may consist of PEEK or consist essentially of PEEK. PEEK, PEI, PAI, XPLE, PVC, and other melt flowable materials may be applied by extrusion. An extrusion process for melt flowable materials may use an extruder of either single screw design or twin-screw design. In either case, the melt flowable material is fed into a hopper that feeds a rotating screw contained within a heated barrel. The screw conveys the melt flowable material to a die that forms the melt flowable material into the desired shape. In the case of a lead, such as lead 13, the melt flowable material(s) is applied at the die either with cross head where the conductor 20 (e.g., the wire) is perpendicular (90°) to the melt flow of the extruder. For multiple layers and different layer materials, multiple extruders can be used either in line or via multiple passes through the same extruder with different melt flow materials applied with each pass.

An enameling process is a multi-pass process wherein the conductor (e.g., the wire) is passed multiple times through a liquid based mixture (e.g., a solvent-based emulsion of the layer material) and then through a die to control the coating thickness of each pass of the wire through the liquid mixture. After passing through the die, the coated wet wire is passed through a cure oven to dive off the solvent carrier and leave the desired thickness of dry solid layer material coating on the wire. Each subsequent pass adds another layer of thickness to the wire until the desired coating thickness is achieved. Very thin coatings can be achieved on very fine wire using the enameling process.

In various implementations, conductor 20 may be configured to have a selected resistance R (ohms) in order to generate a selected quantity of heat Q (joules) when energized by a selected electric current I (amperes) applied for time t(s) according to the Joule heating formula:

Q=I²Rt (1)

For example, as a diameter of conductor 20 decreases, the resistance R increases thus increasing heat Q. Increasing a length of conductor 20 increases resistance R thereby increasing heat generation q. Increasing the current I increases the heat Q. Increasing current application time t increases the resulting heat Q. Resistance R increases with temperature so that increasing temperature increases resistance R.

Conductor 20 may include various conductive materials selected to achieve a desired heat generation Q or to achieve a desired temperature T. Different materials as may comprise conductor 20 have different resistances R that, in turn, result in differing quantities of heat Q being generated or differing rates of heat generation q. (Note, as used herein, Q refers to a quantity of heat (J) and q refers to rate of heat generation (J/s))

For example, conductor 20 may include copper Cu in excess of 99.9% by mass. The resistivity of conductor 20 comprised of copper Cu (>99.9% Cu) has specific electrical resistance of approximately 1.73 μΩcm.

As another example, conductor 20 may include a nickel Ni ferrous Fe alloy. The Ni—Fe alloy may include, for example, between about 25% Ni and about 90% Ni balanced by between about 10% Fe and about 75% Fe. For example, conductor 20 may be configured as Permalloy (approximately 80% Ni and 20% Fe) or as Invar (approximately 36% Ni and 64% Fe). For example, conductor 20 may include between about 52% Ni and about 72% Ni balanced by Fe. A Ni—Fe alloy having about 70% Ni balanced by about 30% Fe may have a specific electrical resistance of about 21u (2 cm. A Ni—Fe alloy having about 52% Ni balanced by about 48% Fe may have a specific electrical resistance of about 37u (2 cm.

As yet another example, conductor 20 may include a copper Cu nickel Ni alloy. The Cu—Ni alloy may, for example, include between about 55% and about 99% Cu balanced by between about 1% and about 45% Ni. For example, the Cu—Ni alloy may include about 44% Ni balanced by Cu; about 21% Ni balanced by Cu; about 11% Ni balanced by Cu. A Cu—Ni alloy having about 1% Ni balanced by about 99% Cu may have a specific electrical resistance of about 2.5 μΩcm. Cu—Ni alloy having about 44% Ni balanced by about 56% Cu may have a specific electrical resistance of about 49 μΩcm. Cu—Ni alloys may further include other metals such as Mn and other materials in various other implementations, as would be readily recognized by those of ordinary skill in the art upon study of this disclosure. Note that implementations of conductor 20 comprised of Cu, Ni-FE alloy and Cu—Ni alloy are exemplary. Other exemplary alloys of which conductor 20 may be comprised include, for example, nickel (Ni)-chromium (Cr); nickel (Ni)-chromium (Cr)-iron (Fe); copper (Cu)-iron (Fe). In various implementations, conductor 20 may be comprised of various other substantially pure metals, alloys, non-metallic materials, and combinations thereof, as would be readily recognized by those of ordinary skill in the art upon study of this disclosure.

For longer length (e.g., larger heating area) the resistance of conductor 20 may be lower so that, for example, conductor 20 is comprised of copper Cu in excess of 99.9%. This may allow more precise control of the desired temperature T with lower energy consumption and increased safety. Lower resistance conductor 20 comprised of Cu (at >99.9%) may ramp up temperature T more slowly and controllably than a high resistance alloy such as iron-chromium-aluminum that has a higher resistance, which may create excessive hot spots (faster ramp rate that would exceed the lower set point temperatures) of the longer length larger heating area at the same given input voltage and amperage.

Medium lengths (e.g., medium heating area applications) may utilize a conductor having a higher resistance R than copper to achieve the same heat generation Q as longer length/larger heating area utilizing >99.9% Cu. Some exemplary resistances per length for different conductors 20 are given in Table 1.

TABLE 1

| | 18 AWG | 12 AWG |
|---|---|---|
| | Ω/ft | Ω/ft |
| Copper (CU) | 0.006385 | 0.001588 |
| Copper-Nickel (Alloy 30) | 0.0185 | 0.0046 |
| Nickel Chromium (Chromel D) | 0.3756 | 0.0934 |

For example, conductor 20 may range in size between 50 AWG (0.001 in) to 4/0 AWG (0.4600 in). In certain implementations, conductor 20 may include wires smaller than 50 AWG and the wires may be wound or woven together. Common sizes for conductor 20 used in floor heating applications, snow and ice melt applications, and industrial heat trace resistance heating applications, for example, are generally in a range between 18 AWG (0.0403 in) and 10 AWG (0.1019 in).

The thickness of insulation layer 30 may be generally in a range between about 0.5 mil (0.0127 mm) and about 8 mil (0.203 mm), in various implementations. Because PEI has a dielectric strength over 830 v/mil (32.7 kV/mm) insulation layer 30 comprised of PEI may have a thickness in a range between about 0.05 mil (0.00127 mm) to about 150 mil, (3.81 mm) depending upon the gauge of conductor 20. For example, insulation layer 30 may be thinner for 40 AWG conductor 20 than a 12 AWG conductor 20. The thickness of insulation layer 30 may be sized for flexibility, impact, and/or dielectric requirements. Because PEI has a higher dielectric strength, PEI may be applied in a thinner coating of insulation to provide the same or better dielectric strength than other materials currently in being used thus resulting in a smaller (thinner) wire OD of insulation layer 30.

For example, conductor 20 may electrically communicate over an AC voltage range generally between 120 V and 240 V or over a DC voltage range DC generally between 5 V and 48 V. An exemplary amperage range for conductor 20 is generally between 0.5 A and 20 A. An exemplary amp draw for conductor 20 at 120 VAC is approximately 1 A/10 ft length. An exemplary amp draw for conductor 20 at 240 VAC systems is 1 A/20 ft length. In certain implementations, conductor 20 may generate heat q in a range generally between 3 W/ft and 20 W/ft. In low voltage applications, conductor 20 may communicate AC at exemplary voltages between about 1 V and about 24 V or DC at exemplary voltages between about 12 V and about 24 V. In certain implementations, conductor 20 may operate at DC voltages of 5 V, 36 V, 48 V or higher. In certain implementations, conductor 20 may operate at amperages generally in a range between 1 A and 20 A, although amperages may exceed 20 A in certain implementations. DC wattage for conductor 20, for example, may range generally between 1 W/ft and 20 W/ft.

When energized, conductor 20 may have a temperature up to about a service temperature of the insulation layer 30 that encloses conductor 20. For example, for an insulation layer 30 comprised of PEEK, conductor 20 may have a temperature of about 250° C., which is the service temperature of certain implementations of PEEK. For an insulation layer 30 comprised of PEI, for example, conductor 20 may have a temperature of about 170° C., which is the service temperature of certain implementations of PEI. PEI melt temperatures may be around 290-300° C. and glass transition temperatures of 215-217° C. (419-422° F.).

An exemplary PEI is available from Mitsubishi Chemical Group as Duratron™ U1000 that generally has, inter alia, the following material properties:
Rockwell M hardness (ISO 2039-2): 115
Rockwell M hardness (ASTM D785): 112
Rockwell R hardness (ASTM D785): 125
Charpy impact strength (unnotched, ISO 179-1/1eU)—no break
Charpy impact strength (notched, ISO 179-1/1eA): 3.5 kJ/m²
Thermal conductivity 0.24 W/(K m)
Continuous service temperature of 170° C.
Heat deflection temperature of 195° C.
Dielectric strength of about 27 kV/mm

An exemplary PEEK is available from Mitsubishi Chemical Group as Ketron™ 1000 that generally has, inter alia, the following material properties:
Rockwell M hardness (ISO 2039-2): 105
Rockwell R hardness (ASTM 2240): 126
Charpy impact strength (unnotched, ISO 179-1/1eU)—no break
Charpy impact strength (notched, ISO 179-1/1eA)—3.5 kJ/m²
Thermal conductivity 0.25 W/(K·m)
Continuous service temperature of 250° C. (480° F.)
Heat deflection temperature of 160° C. or 320° F.
Dielectric strength 24 KV/mm

Layer 40 (and additional layers) may be configured for RF shielding, to provide structural support, to facilitate heat transfer (e.g., conduct heat), to contain conductive layer 20 enclosed by insulation layer 30, to provide additional scuff, cut and abrasion resistance, to provide added electrical dielectric strength, to provide added impact resistance, to provide added cut through resistance, for ground fault protection, to provide color coding for electrical connections (white, green, black, red, blue, etc.) or to provide various other functions, as would be readily recognized by those of ordinary skill in the art upon study of this disclosure. Layer 40 may be comprised of a thermoset material or thermoplastic. Layer 40, for example, may be comprised of various plastics such as silicone, PVC, XLPE, FEP, ETFE, and PFA, metal including solid and braided constructions, metal coated plastic (e.g., aluminized mylar), and other materials, as would be readily recognized by those of ordinary skill in the art upon study of this disclosure.

Insulation layer 30 may be extruded or enameled onto conductor surface 21 of conductor 20 to enclose and bond to conductor 20. Layer 40 may be extruded or enameled onto insulation layer 30 to enclose insulation layer 30 in some implementations. Layer 40 may be tubed onto insulation layer 30 in biased engagement with insulation layer 30 or in intimate contact with insulation layer 30 with perhaps some gaps between layer 40 and insulation layer 30, in other implementation. Extrusion or enameling of layer 40 onto insulation layer 30 may be either concurrent with or subsequent to extrusion or enameling of insulation layer 30 onto conductor 20, in various implementations. In various implementations, exemplary lead 13 may include various other layer(s) external of insulation layer 30.

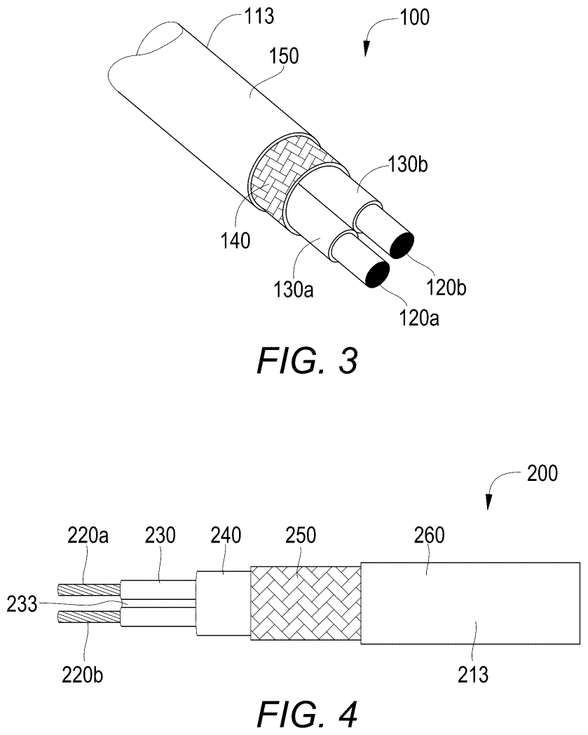

As illustrated in FIG. 3, lead 113 of exemplary electrically resistive heating apparatus 100 includes conductors 120a, 120b, insulation layers 130a, 130b, layer 140, and layer 150. Insulation layers 130a, 130b are disposed in biased engagement around conductors 120a, 120b, respectively, as illustrated, insulation layers 130a, 130b may include PEI and/or PEEK, in various implementations. As illustrated, layer 140 is formed of braided metal and layer 150 defines the exterior of lead 113. Insulation layers 130a, 130b may be of separate construction and subsequently combined together to form either a separable construction or a unitary construction. For example, insulation layer 130a may be extruded or enameled onto conductor 120a, and insulation layer 130b may be extruded or enameled onto conductor 120b. The combination conductor 120a and insulation layer 130a may then be combined with the combination conductor 120b and insulation layer 130b, for example, by solvent welding or thermal welding to form a unitary construction. In other implementations, the combination conductor 120a and insulation layer 130a is held together mechanically with the combination conductor 120b and insulation layer 130b by layer 140.

As illustrated in FIG. 4, lead 213 of exemplary electrically resistive heating apparatus 200 includes conductors 220a, 220b, insulation layer 230, layer 240, layer 250, and layer 260. Insulation layer 230 is disposed in biased engagement around both conductors 220a, 220b, as illustrated, with portions of insulation layer 230 biasingly engaged with conductor 220a and other portions of insulation layer 230 biasingly engaged with conductor 220b and separated from one another by septum 233. Thus, in this implementation, insulation layer 230 may be extruded or enameled onto conductors 220a, 220b generally simultaneously to form a unitary structure (in contrast with the exemplary FIG. 3 implementation that has no septum). Insulation layer 230 includes PEI, PEEK, or both PEI and PEEK, in various implementations. Insulation layer 230 includes PES, PPSU, and/or PSUL, in various implementations. Various implementations of lead 213 may include one or more drains (not shown).

As illustrated in FIG. 4, layer 240 is encloses insulation layer 230 in biased engagement with insulation layer 230, layer 250 encloses layer 240 in biased engagement with layer 240, and layer 260 encloses layer 250 in biased engagement with layer 250. Layer 250 is comprised of metal of braided construction, as illustrated, to provide RF shielding, or ground fault protection. Layer 240 and layer 260 form an inner jacket and an outer jacket, respectively, in this implementation. Other implementations may variously omit layers 240, 250, 260 or may include additional layer(s). In some implementations, layer 240 may be bonded to insulation layer 230 while, in other implementations, layer 240 may be in intimate contact with insulation layer 230 but not bonded to insulation layer 230. Layers 240, 250, 260 may be variously in biased engagement but not bonded or in bonded engagement with one another. Layer 240 may be in gapped relation with insulation layer 230 and layers 240, 250, 260 may be variously in gapped relation with the layer being enclosed thereby, in various other implementations.

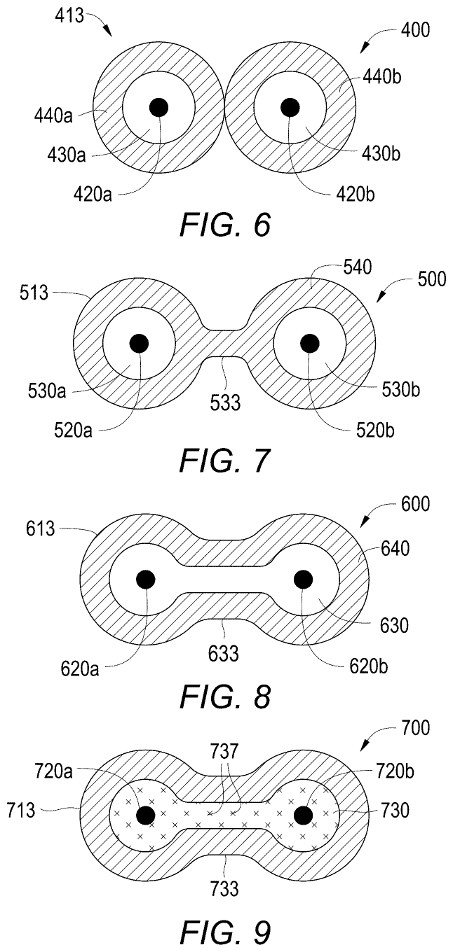

Note that leads having two conductors, such as lead 113 having conductors 120a, 120b, lead 213 having conductors 220a, 220b, lead 413 having conductors 420a, 420b (see FIG. 6), lead 513 having conductors 520a, 520b (see FIG. 7), lead 613 having conductors 620a, 620b (see FIG. 8), and lead 713 having conductors 720a, 720b (see FIG. 9), may facilitate installation. For example, the two-conductor lead is laid in position, the farthest end stripped, and the two conductors are connected together thereby completing a circuit. This makes installation and design easier as only one controller, such as controller 17, is required and no return wire is needed. Leads such as lead 113, 213, 413, 513, 613, 713 may further include a ground wire (not shown) of a gauge commensurate with the gauge of the conductors, such as conductors 120a, 120b, 220a, 220b, 420a, 420b, 520a, 520b, 620a, 620b, 720a, 720b. Certain implementations may include more than two conductors depending upon application requirements.

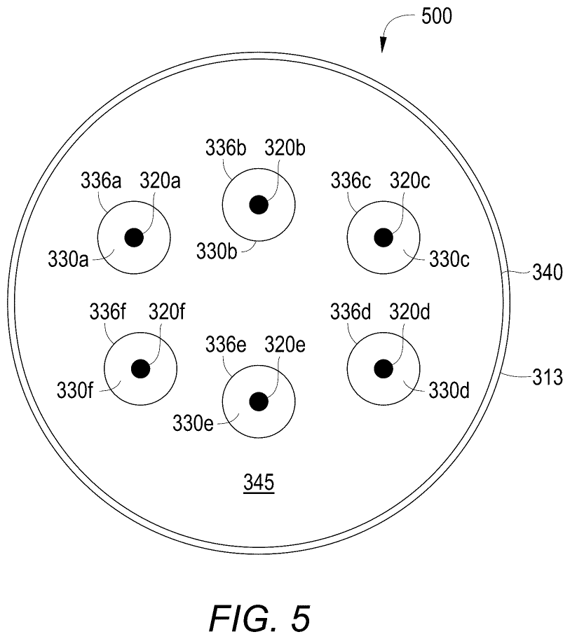

FIG. 5 illustrates exemplary lead 313 of exemplary electrically resistive heating apparatus 300 that includes insulation layers 330a, 330b, 330c, 330d, 330e, 330f disposed in biased engagement around conductors 320a, 320b, 320c, 320d, 320e, 320f to form electrical wires 336a, 336b, 336c, 336d, 336e, 336f, respectively. Electrical wires 336a, 336b, 336c, 336d, 336e, 336f are disposed within void space 345 defined by layer 340, in this implementation. Other implementations may embed wires 336a, 336b, 336c, 336d, 336e, 336f in layer 340 thereby omitting void space 345. Also, other implementations may include any number of wires, such as wires 336a, 336b, 336c, 336d, 336e, 336f.

FIG. 6 illustrates exemplary lead 413 of exemplary electrically resistive heating apparatus 400 that includes conductors 420a, 420b enclosed in biased engagement by insulation layers 430a, 430b, respectively. Insulation layers 430a, 430b are enclosed in biased engagement by layers 440a, 440b, respectively, as illustrated.

In some implementations, the combination conductor 420a, insulation layer 430a, layer 440a may then form a structure separate from the combination conductor 420b, insulation layer 430b, layer 440b, and one or more additional layer(s) (not shown) may enclose both the combination conductor 420a, insulation layer 430a, layer 440a and the combination conductor 420b, insulation layer 430b, layer 440b to form lead 413. In other implementations, the combination conductor 420a, insulation layer 430a, layer 440a and the combination conductor 420b, insulation layer 430b, layer 440b may be, for example, solvent welded or thermally welded together to form a unitary structure. Insulation layers 430a, 430b may be comprised of PEI, PEEK, or combinations thereof, and layers 440a, 440b may, for example, be comprised variously of ETFE, PFA, XLPE, or FEP. By comprising insulation layers 430a, 430b of PEI, PEEK, or combinations thereof, the thickness of layers 440a, 440b may be reduced and thus the thickness of lead 413 may be reduced, for example, in comparison with the thickness of a lead insulated only by ETFE, PFA, XLPE, or FEP.

FIG. 7 illustrates lead 513 of exemplary electrically resistive heating apparatus 500 that includes conductors 520a, 520b enclosed in biased engagement by insulation layers 530a, 530b, respectively. Insulation layers 530a, 530b are enclosed in biased engagement by layer 540 with layer 540 forming septum 533, as illustrated, so that lead 513 has a unitary structure. Insulation layers 530a, 530b are comprised of PEI, PEEK, or combinations thereof, and layer 540 may, for example, be comprised variously of ETFE, PFA, XLPE, FEP, in various implementations. Insulation layers 530a, 530b may be extruded onto conductors 520a, 520b and layer 540 extruded onto insulation layers 530a, 530b either generally simultaneously or in successive operations to form lead 513. Of course, lead 513 may include various additional layers external to layer 540, in various other implementations.

FIG. 8 illustrates lead 613 of exemplary electrically resistive heating apparatus 600 that includes conductors 620a, 620b enclosed in biased engagement by insulation layer 630. Insulation layer 630 is enclosed in biased engagement by layer 640 with insulation layer 630 and layer 640 forming septum 633, as illustrated, so that lead 613 has a unitary structure. Insulation layer 630 is comprised of PEI, PEEK, or combinations thereof, and layer 640 is, for example, comprised variously of ETFE, PFA, XLPE, FEP, in various implementations. Insulation layer 630 may be extruded or enameled onto conductors 620a, 620b and layer 640 extruded or enameled onto insulation layer 630 generally simultaneously (e.g., as simultaneous or consecutive operations of the same manufacturing process) to form lead 613. Lead 613 may include various additional layers external to layer 640 or layer 640 may be omitted, in various implementations. Layer 640 may be comprised of PEEK or PEI, in certain implementations.

FIG. 9 illustrates exemplary lead 713 of exemplary electrically resistive heating apparatus 700 that is self-regulating and includes conductors 720a, 720b enclosed in biased engagement by insulation layer 730 that, in turn, is enclosed in biased engagement by layer 740. Insulation layer 730 and layer 740 form septum 733, as illustrated. Septum 733 may be pinched in thus having a dog bone shape, as illustrated in FIG. 9, or, in other implementations, septum 733 may be uniformly thick, for example, so that lead 713 has an oval-shaped cross-section. In certain implementations, layer 740 may be tubed onto insulation layer 730 so that in a cross-sectional view layer 740 appears like a rubber band stretched over the dog bone shape of septum 733 with an air gap over septum 733 between insulation layer 730 and layer 740 and layer 740 in biased contact with insulation layer 730 around the outer ends of insulation layer 730.

In this self-regulating implementation illustrated in FIG. 9, insulation layer 730 includes PEEK and/or PEI and is made semiconductive by further including conductive particles 737 comprising, for example, carbon nanoparticles, carbon nanotubes, carbon black, polyaniline (PANI), polypyrrole (PPY), metallic particles such as iron Fe or manganese Mn, and metal cations such as Fe³⁺, Cu²⁺, Zn²⁺, Ni²⁺, Co²⁺. Thus, insulation layer 730 is configured as a conductive polymer matrix, in this implementation. Conductors 720a, 720b act as bus wires communicating electrically with insulation layer 730 particularly between conductors 720a, 720b (e.g., particularly via septum 733), in this implementation.

In this exemplary self-regulating implementation, insulation layer 730 particularly septum 733 thermally contracts as lead 713 is cooled so that conductors 720a, 720b become closer together thereby allowing more energy to flow thus increasing heat output because insulation layer 730 is semiconductive. As lead 713 warms from the increased heat output, insulation layer 730 particularly septum 733 expands thermally causing conductors 720a, 720b to become further apart thereby decreasing energy flow and decreasing the heat output, in this implementation. The material of insulation layer 730 and of layer 740 may be selected to allow for such thermal expansion and thermal contraction. In some self-regulating implementations, the entirety of insulation layer 730 may be semiconductive (e.g., the entirety of insulation layer includes conductive particles). In other self-regulating implementations, only portions of insulation layer 730 including septum 733 may be semiconductive (e.g., only septum 733 includes conductive particles). Insulation layer 730 may form a very thin layer enclosing conductors 720a, 720b. Because insulation layer 730 is semiconductive, layer 740 electrically insulates lead 713, in this implementation.

In one implementation, both insulation layer 730 and layer 740 are comprised either of PEEK or of PEI so as to have similar coefficients of thermal expansion. Comprising both insulation layer 730 and layer 740 either of PEEK or of PEI may facilitate manufacture as application of layer 740 by extrusion or enameling over insulation layer 730 may not thermally damage insulation layer 730. In another implementation, insulation layer 730 is comprised of PEEK or PEI impregnated with conductive particles 737 and layer 740 is comprised, for example, variously of ETFE, PFA, XLPE, FEP. In yet another implementation, insulation layer 730 is impregnated with conductive particles 737 and is further variously comprised of, for example, radiation cured polyolefins (examples: polyetheylene or polypropolyene), ETFE, PFA, XLPE, FEP. Layer 740 may be comprised variously of PEEK, PEI, PES, PPSU, and PSUL. Also, it should be recognized that exemplary lead 713 illustrated in FIG. 9 as well as exemparly leads 413, 513, 613 illustrated in FIGS. 6, 7, 8, respectively, form a core construction that may be further comprised of additional layers such as layer 150 of exemplary lead 113 illustrated in FIG. 3, and layers 250, 260 of exemplary lead 213 illustrated in FIG. 4.

The ASTM D3203 dynamic cut-through test (see www.instron.com/wp-content/uploads/2024/07/cp110778-astm-d3032-dynamic-cut-thru-fixture.pdf and ASTM D3032, Section 22/MIL-DTL22759/8A Dynamic Cut Through Fixture both hereby incorporated by reference in their entireties herein) measures the resistance of a wire insulation to the penetration of a cutting surface and simulates the type of damage that may occur when a wire is forced by mechanical loading against a sharp edge. The ASTM D3203 dynamic cut-through test apparatus (not shown) may include a 24 VDC detection circuit that senses the contact between the cutting edge and the conductors. Once contact is made, the PIP signal may stop the test. Exemplary dynamic cut through values from ASTM D3203 for various materials are listed in Table 2 with larger dynamic cut through values indicating greater resistance to cut through, and, thus, greater strength. As indicated in Table 2, PEI and PEEK have greater resistance to cut through than, for example, ETFE, PFA and XLPE.

TABLE 2

| | Dynamic Cut |
|---|---|
| Material | Through Value (N) |
| ethylene tetrafluoroethylene (ETFE) | 15-20 |
| perfluoroalkoxy (PFA) | 20-25 |
| cross-linked polyethylene (XLPE) | 0-15 |
| polyetherimide (PEI) | 25-30 |
| polyether ether ketone (PEEK) | 30-35 |
| fluorinated ethylene propylene (FEP) | 15-20 |

In Table 3, exemplary physical properties of PEI and PEEK are compared with exemplary physical properties of other materials that may be used to insulate conductors in order to form a lead. As indicated in Table 3, PEI and PEEK have a combination of high tensile and lower elongation resulting in a tougher material than, for example, ETFE, PFA, FEP, and XLPE. Note that the Charpy test and the Izod test have different test standards depending upon the type of material that is being tested and the results of the Charpy test and the Izod tests are not comparable. Thus, the cut through data in Table 2, and the tensile strength, elongation at break, Shore D hardness, and thermal stability data in Table 3 may provide more comparable physical properties than impact resistance derived from the Charpy test or Izon test.

TABLE 3

| | Tensile | Elongation | | Thermal |
|---|---|---|---|---|
| | Strength | at Break | Hardness | Stability |
| Material | (MPa) | (%) | (Shore D) | (° C.) |
| ETFE | 30-40 | 200-300 | 55-65 | 150-200 |
| PFA | 20-30 | 200-300 | 60-70 | 260-300 |
| XLPE | 20-30 | 300-600 | 50-60 | 80-100 |
| PEI | 70-90 | 50-100 | 85-90 | 200-220 |
| PEEK | 90-100 | 20-50 | 90-95 | 300-350 |

The impact strength of plastics is crucial for applications requiring durability and resistance to breakage. Table 4 provides an exemplary comparison of the impact strength for several materials, including PEI, PEEK, XLPE, FEP, ETFE, and PFA.

TABLE 4

| | Impact | |
|---|---|---|
| | Strength | |
| Material | (J/m²) | Notes |
| PEI | 50-100 | High strength and thermal stability. |
| XLPE | 20-30 | Good flexibility and impact resistance. |
| PEEK | 30-50 | Excellent mechanical properties and chemical |
| | | resistance. |
| FEP | 10-20 | Lower impact strength, but excellent chemical |
| | | resistance. |
| ETFE | 30-40 | Good toughness and resistance to UV and chemicals. |
| PFA | 10-15 | Similar to FEP, with lower impact strength. |

Leads used in radiant heating are designed to operate at various temperature ranges depending on their construction and intended use. Table 5 provides exemplary temperature specifications for different types of leads used in radiant heating applications.

TABLE 5

| | | | |
|---|---|---|---|
| | Maximum | Intermittent | |
| | Continuous | Exposure | |
| Type | Temperature | Temperature | VoltageOptions |

High-Temperature Heating Cables

| | | | |
|---|---|---|---|
| High-Temperature | 302° F. | 392° F. | 110-120 V, |
| Self-Regulating | (150° C.) | (200° C.) | 208-277 V |
| High-Temperature Wire | Up to 1200° F. | Not | Up to 600 |
| | (649° C.) | specified | Volts |

Low-Temperature Heating Cables

| | | | |
|---|---|---|---|
| Low-Temperature | 150° F. | 185° F. | 110-120 V, |
| Self-Regulating | (65° C.) | (85° C.) | 208-277 V |

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72(b) only. Accordingly, the Abstract is not intended to identify key elements of the apparatus and methods disclosed herein or to delineate the scope thereof. Upon study of this disclosure and the exemplary implementations herein, one of ordinary skill in the art may readily recognize that various changes, modifications and variations can be made thereto without 25 departing from the spirit and scope of the inventions as defined in the following claims.

The invention claimed is:

1. An electrically resistive heating apparatus, comprising:
a conductor having a selected resistance to generate a selected quantity of heat when energized in order to provide resistive heating;
an insulation layer enclosing the conductor in biased engagement with the conductor;
and wherein the insulation layer comprises a material selected from a group consisting of polyetherimide (PEI) and polyether ether ketone (PEEK).

2. The apparatus of claim 1, wherein the conductor is operable within a temperature range of from about 170° C. to about 250° C. when energized.

3. The apparatus of claim 1, further comprising:
a layer enclosing the insulation layer wherein the layer is in biased engagement with the insulation layer.

4. The apparatus of claim 1, wherein at least portions of the insulation layer comprise conductive particles to make the at least portions of the insulation layer semiconductive.

5. The apparatus of claim 1, a layer enclosing the insulation layer wherein the layer comprises a material selected from a group consisting of ethylene tetrafluoroethylene (ETFE), perfluoroalkoxy (PFA), cross-linked polyethylene (XLPE), and fluorinated ethylene propylene (FEP).

6. The apparatus of claim 1, wherein the insulation layer has a thickness within a range from about 0.5 mil (0.0127 mm) to about 8 mil (0.203 mm).

7. The apparatus of claim 1, wherein the insulation layer has a thickness within a range between about 0.05 mil (0.00127 mm) and about 150 mil (3.81 mm).

8. The apparatus of claim 1, wherein the conductor generates heat at a rate between about 9.84 W/m (3 W/ft) and about 65.6 W/m (20 W/ft).

9. The apparatus of claim 1, wherein the conductor comprises a material selected from a group consisting of Cu, Ni, a Ni-FE alloy and a Cu—Ni alloy, a Ni—Cr alloy, a Ni—Cr—Fe alloy and a Cu—Fe alloy.

10. The apparatus of claim 1, further comprising:
a controller in electrical cooperation with the conductor to control the rate of heat being generated by the conductor.

11. A lead for electrically resistive heating, comprising:
a conductor having a resistance selected to operate at a selected temperature when energized;
an insulation layer enclosing the conductor in biased engagement with the conductor;
and wherein the insulation layer comprises a material selected from a group consisting of polyetherimide (PEI) and polyether ether ketone (PEEK).

12. The apparatus of claim 11, wherein the insulation layer further comprises a material selected from glass fiber, carbon fiber, polyethersulfone (PES), polyphenylenesulfide (PPSU), and polysulphone unfilled (PSUL).

13. The apparatus of claim 11, wherein the selected temperature is within a range of from about 170° C. to about 250° C.

14. The apparatus of claim 11, further comprising:
a layer enclosing the insulation layer.

15. The apparatus of claim 11, a layer enclosing the insulation layer wherein the layer comprises a material selected from a group consisting of ethylene tetrafluoroethylene (ETFE), perfluoroalkoxy (PFA), cross-linked polyethylene (XLPE), and fluorinated ethylene propylene (FEP).

16. The apparatus of claim 11, wherein the insulation layer has a thickness within a range between about 0.5 mil (0.0127 mm) and about 8 mil (0.203 mm).

17. The apparatus of claim 11, wherein the insulation layer has a thickness within a range between about 0.05 mil (0.00127 mm) and about 150 mil (3.81 mm).

18. The apparatus of claim 11, wherein the conductor generates heat at a rate between about 9.84 W/m (3 W/ft) and about 65.6 W/m (20 W/ft).

19. An electrically resistive heating apparatus, comprising:
a substrate;
a lead disposed within the substrate, the lead comprising:
a conductor having a selected resistance to generate a selected quantity of heat when energized in order to provide resistive heating;
an insulation layer enclosing the conductor in biased engagement with the conductor, the insulation layer comprising a material selected from a group consisting of polyetherimide (PEI) and polyether ether ketone (PEEK);
and a controller in electrical cooperation with the lead to regulate the quantity of heat being generated.

20. The apparatus of claim 11, wherein the conductor generates heat at a rate between about 9.84 W/m (3 W/ft) and about 65.6 W/m (20 W/ft).
